(19) United States
(12) Patent Application Publication
(10) Pub. No.: US 2026/0208554 A1
(43) Pub. Date: Jul. 23, 2026

(54) HEAT PUMP SYSTEM FOR AN ELECTRICALLY OPERATED VEHICLE

(71) Applicant: HELLA GmbH & Co. KGaA, Lippstadt (DE)

(72) Inventor: Sebastian TIEMEYER, Dortmund (DE)

(73) Assignee: HELLA GmbH & Co. KGaA, Lippstadt (DE)

(21) Appl. No.: 19/575,371

(22) Filed: Mar. 23, 2026

Related U.S. Application Data
(63) Continuation of application No. PCT/EP2024/074196, filed on Aug. 29, 2024.

(30) Foreign Application Priority Data
Sep. 22, 2023 (DE) 10 2023 125 798.6

(51) Int. Cl. B60H 1/00; B60L 58/26

(52) U.S. Cl. CPC B60H 1/00278; B60H 1/00885; B60L 58/26; B60H 2001/00307

(57) ABSTRACT

A heat pump system for an electrically operated vehicle. A coolant side circulates a coolant and a refrigerant side, which is fluidically separate from the coolant side, circulates a refrigerant. The coolant side and the refrigerant side are in a heat transfer connection. The coolant side has four flow sections for the coolant, a valve system for distributing the coolant, and two coolant branches. The heat pump system is designed such that in a first operating state, a coolant flow passes through the flow section, the flow section, the coolant branch, the coolant branch, and the flow section, while a coolant flow passes through the flow section, and in a second operating state, a coolant flow passes through the flow section, the coolant branch, and the flow section, while a coolant flow passes through the flow section, through the coolant branch, and through the flow section.

This nonprovisional application is a continuation of International Application No. PCT/EP2024/074196, which was filed on Aug. 29, 2024, and which claims priority to German Patent Application No. 10 2023 125 798.6, which was filed in Germany on Sep. 22, 2023, and which are both herein incorporated by reference.

### BACKGROUND OF THE INVENTION

### Field of the Invention

The present invention relates to a heat pump system for an electrically operated vehicle.

### Description of the Background Art

Heat pump systems for electrically operated vehicles are known from the prior art in numerous design variants. The known heat pump systems comprise a coolant side for circulating a coolant and a refrigerant side, which is fluidically separate from the coolant side, for circulating a refrigerant, wherein the coolant side and the refrigerant side are in a heat transfer connection, and wherein the coolant side has a first flow section for the coolant, a second flow section for the coolant, a third flow section for the coolant, a fourth flow section for the coolant, a valve system for coolant-side distribution of the coolant, and two coolant branches.

This is the starting point of the present invention.

### SUMMARY OF THE INVENTION

It is therefore an object of the present invention to improve a heat pump system for an electrically operated vehicle.

This object is achieved, in an example, by a heat pump system W, which is characterized in that in a first operating state of the heat pump system, a coolant flow of the coolant passes through the first flow section, then through the second flow section, then through the coolant branch, then through a second coolant branch, and then through the fourth flow section, while at the same time, a coolant flow of the coolant passes separately through the third flow section, and in a second operating state of the heat pump system, a coolant flow of the coolant passes through the first flow section, then through the coolant branch, and then through the fourth flow section, while at the same time, a coolant flow of the coolant passes separately through the second flow section, then through the coolant branch, and then through the third flow section.

A significant advantage of the invention in particular is that a heat pump system for an electrically operated vehicle is improved. Due to the inventive design of the heat pump system W, it is possible to significantly improve the efficiency of the heat pump system W and thus of a thermal management system of an electrically operated vehicle equipped therewith in a simple manner in terms of circuitry. This is because the heat pump system according to the invention allows very flexible heat-transfer coupling between heat sources of the heat pump system W and heat sinks of the heat pump system. Accordingly, inherently complex thermal management tasks for electrically operated vehicles can be solved much more easily and thus more cost-effectively.

In principle, the heat pump system can be freely selectable within suitable wide limits in terms of type, mode of operation, components, material, and dimensions. For example, the heat pump system according to the invention is advantageously usable for an electrically operated vehicle, both for strictly electric vehicles and for so-called hybrid vehicles, i.e., vehicles which on the one hand have an internal combustion engine and on the other hand have an electric motor for driving the vehicle. This is particularly intended for land vehicles such as road vehicles or the like. However, the invention is also usable for other types of vehicles.

The heat pump system can be designed in such a way that in a third operating state of the heat pump system, a coolant flow passes through the first flow section, then through the coolant branch, then through the coolant branch, and then through the third flow section. The above-mentioned advantages according to the invention are further enhanced in this way.

The heat pump system can have a fifth flow section for the coolant, wherein the fifth flow section is connectable to the third flow section and/or to the fourth flow section via the valve system. This further improves the flexibility and efficiency of the heat pump system according to the invention.

In this regard, see, for example, one advantageous refinement of the last-mentioned example of the heat pump system according to the invention, which provides that the heat pump system van be designed in such a way that in a fourth operating state of the heat pump system, a coolant flow of the coolant passes through the first flow section, then through the coolant branch, then through the fourth flow section, and then through the fifth flow section, while at the same time, a coolant flow of the coolant passes separately through the third flow section.

Another advantageous refinement of the heat pump system according to the invention provides that the heat pump system can be designed in such a way that in a fifth operating state of the heat pump system, a coolant flow of the coolant passes through the first flow section, then through the coolant branch, then through the coolant branch, and then through the third flow section, while at the same time, a coolant flow of the coolant passes through the second flow section, then through the coolant branch, and then through the third flow section. In this way, the heat pump system according to the invention is designed to be even more flexible and efficient, alternatively or in addition to the above-mentioned refinements of the invention.

A further advantageous refinement of the heat pump system according to the invention provides that the heat pump system can be designed in such a way that in a sixth operating state of the heat pump system, on the one hand a coolant flow of the coolant passes through the first flow section, then through the coolant branch, and then through the fourth flow section, and/or on the other hand a coolant flow of the coolant passes through the first flow section, then through the coolant branch, then through the coolant branch, and then through the third flow section. This provides a further alternative or additional refinement of the heat pump system according to the invention for increasing the flexibility and efficiency of the heat pump system according to the invention.

Another advantageous refinement of the heat pump system according to the invention provides that the heat pump system is designed in such a way that in a seventh operating state of the heat pump system, on the one hand a coolant flow of the coolant passes through the first flow section, then through the coolant branch, and then through the fourth flow section, and/or on the other hand a coolant flow of the coolant passes through the first flow section, then through the coolant branch, then through the coolant branch, and then through the third flow section, and in addition to the coolant flow and/or the coolant flow, a coolant flow passes through the second flow section, then through the coolant branch, and then through the third flow section. In this way, the flexibility and efficiency of the heat pump system according to the invention are increased in another alternative or additional way.

In a further advantageous refinement of the heat pump system according to the invention, it is provided that the heat pump system has a sixth flow section for the coolant, wherein the sixth flow section is connectable upstream in a flow-conducting manner to the third flow section via the valve system. This further enhances the above-mentioned advantages.

The same applies to another refinement of the heat pump system according to the invention, according to which the heat pump system has a seventh flow section for the coolant, wherein the seventh flow section is arranged fluidically parallel to the first flow section and downstream from the second flow section in such a way that a coolant flow of the coolant downstream from the second flow section is dividable into the first flow section and the seventh flow section via the valve system.

Furthermore, a particularly advantageous refinement of the heat pump system according to the invention provides that the coolant branch and the coolant branch are immediately and directly connected to one another in a flow-conducting manner. The coolant branches are thus connected to one another in a flow-conducting manner without connecting additional components such as valves or the like in between. The structural design, manufacturing design, and circuit design of the heat pump system according to the invention are greatly simplified in this way.

As stated above, the heat pump system according to the invention is freely selectable within suitable wide limits. This applies in particular also to the type and number of components arranged in the particular flow section.

A heat source can be arranged in the first flow section, and/or that a heat exchanger for exchanging heat between the coolant and the open surroundings is arranged in the second flow section, and/or that a heat exchanger for cooling the coolant via the refrigerant is arranged in the third flow section. This specifies components that are particularly suitable for the functioning of the heat pump system according to the invention for the respective flow section mentioned above.

The same applies to the advantageous refinements stated below.

A vehicle battery of the vehicle can be arranged in the fifth flow section. The vehicle battery is designed in particular for the drive of an electric motor for driving the vehicle.

A heat exchanger for cooling air in a vehicle interior of the vehicle can be arranged in the sixth flow section.

Furthermore, one advantageous refinement of the heat pump system provides that a heat exchanger for transferring heat to the coolant can be arranged in the seventh flow section, and/or that a further heat exchanger for transferring heat to air in a vehicle interior of the vehicle is arranged in the seventh flow section.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of the heat pump system according to the invention according to a first operating state, in a process diagram,

FIG. 2 shows the example of the heat pump system according to the invention according to a second operating state, in a process diagram,

FIG. 3 shows the example of the heat pump system according to the invention according to a third operating state, in a process diagram,

FIG. 4 shows the exemplary embodiment of the heat pump system according to the invention according to a fourth operating state, in a process diagram,

FIG. 5 shows the example of the heat pump system according to the invention according to a fifth operating state, in a process diagram,

FIG. 6 shows the example of the heat pump system according to the invention according to a sixth operating state, in a process diagram, and

FIG. 7 shows the example of the heat pump system according to the invention according to a seventh operating state, in a process diagram.

### DETAILED DESCRIPTION

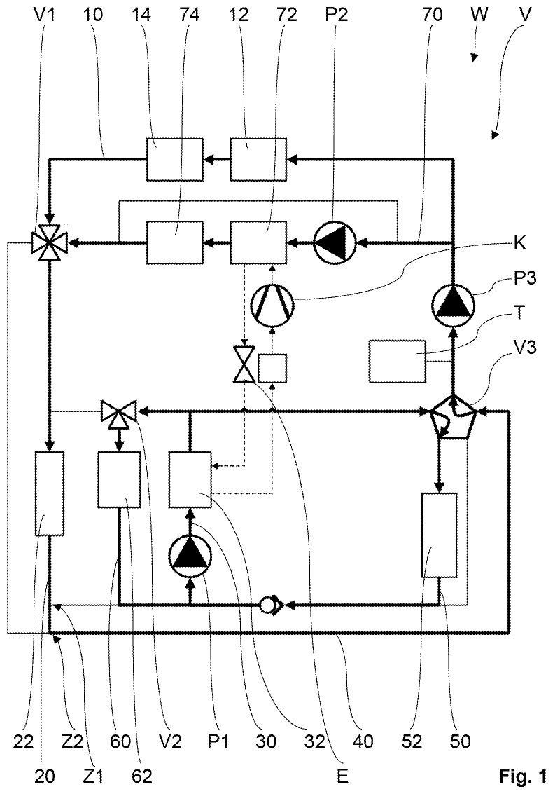

FIGS. 1 through 7 illustrate, strictly by way of example, an exemplary embodiment of the heat pump system W according to the invention for an electrically operated vehicle.

The vehicle, which can be designed as a strictly electric vehicle for road traffic, is not illustrated in greater detail.

The vehicle has a heat pump system W for thermal management purposes. The heat pump system W comprises a coolant side for circulating a coolant (not illustrated) and a refrigerant side, which is fluidically separate from the coolant side, for circulating a refrigerant (likewise not illustrated), wherein the coolant side and the refrigerant side are in a heat transfer connection, and wherein the coolant side has a first flow section 10 for the coolant, a second flow section 20 for the coolant, a third flow section 30 for the coolant, a fourth flow section 40 for the coolant, a valve system V for coolant-side distribution of the coolant, a coolant branch Z1, and a coolant branch Z2.

Furthermore, the heat pump system W of the present exemplary embodiment comprises a fifth flow section 50 for the coolant, a sixth flow section 60 for the coolant, and a seventh flow section 70 for the coolant, wherein the fifth flow section 50 is connectable upstream in a flow-conducting manner to the third flow section 30 and/or to the fourth flow section 40 via the valve system V, and wherein the sixth flow section 60 is connectable upstream in a flow-conducting manner to the third flow section 30 via the valve system V, and wherein the seventh flow section 70 is arranged fluidically parallel to the first flow section 10 and downstream from the second flow section 20 in such a way that a coolant flow of the coolant downstream from the second flow section 20 is dividable into the first flow section 10 and the seventh flow section 70 via the valve system V.

In addition, the heat pump system W here also comprises the following:

The coolant branch Z1 and the coolant branch Z2 are immediately and directly connected to one another in a flow-conducting manner.

A heat source, namely, a power electronics unit 12 and an electric motor 14 for driving the vehicle, is arranged in the first flow section 10, and a heat exchanger, namely, a front radiator 22 for exchanging heat between the coolant and the open surroundings, is arranged in the second flow section 20, and a heat exchanger, namely, a chiller 32 for cooling the coolant via the refrigerant, is arranged in the third flow section 30, and a vehicle battery 52 of the vehicle for the electric motor 14 is arranged in the fifth flow section 50, and a heat exchanger, namely, an interior cooler 62 for cooling air (not illustrated) in a vehicle interior (likewise not illustrated) of the vehicle is arranged in the sixth flow section 60, and on the one hand a heat exchanger, namely, a liquid-cooled condenser 72 for transferring heat to the coolant, and on the other hand a further heat exchanger, namely, an interior heater 74 for transferring heat to the air in the vehicle interior of the vehicle, are arranged in the seventh flow section 70. The vehicle interior is also referred to below as the vehicle cabin.

The valve system V here includes, among other things, the valves V1, V2, and V3. The valve V1 is designed here as a 4-way valve, the valve V2 as a 3-way valve, and the valve V3 as a 5-way valve. Furthermore, the heat pump system W of the exemplary embodiment also has the following components: refrigerant compressor K, expansion valve E, coolant pumps P1, P2, and P3, and a coolant tank T which at the same time is designed as an equalizing vessel.

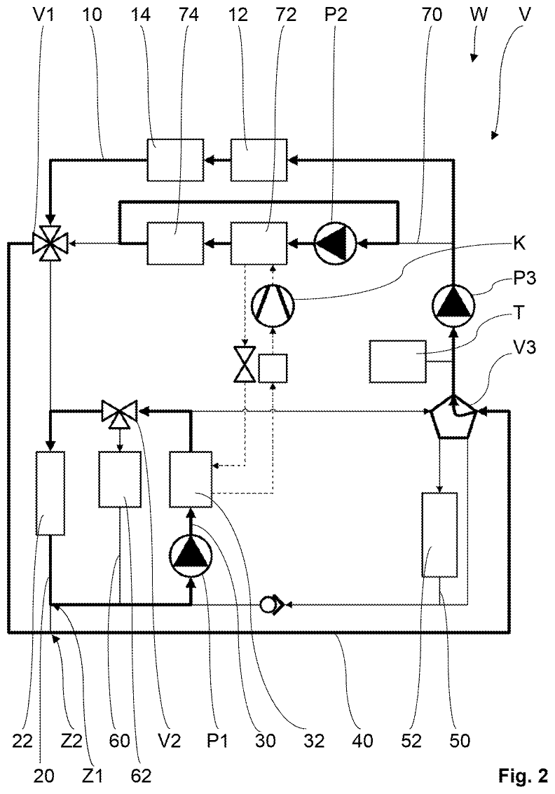

According to the invention, the heat pump system W is designed in such a way that in a first operating state of the heat pump system W, a coolant flow 1A of the coolant passes through the first flow section 10, then through the second flow section 20, then through the coolant branch Z1, then through the coolant branch Z2, and then through the fourth flow section 40, while at the same time, a coolant flow 1B of the coolant separately passes through the third flow section 30, and in a second operating state of the heat pump system W, a coolant flow 2A of the coolant passes through the first flow section 10, then through the coolant branch Z2, and then through the fourth flow section 40, while at the same time, a coolant flow 2B of the coolant passes separately through the second flow section 20, then through the coolant branch Z1, and then through the third flow section 30; see FIGS. 1 and 2.

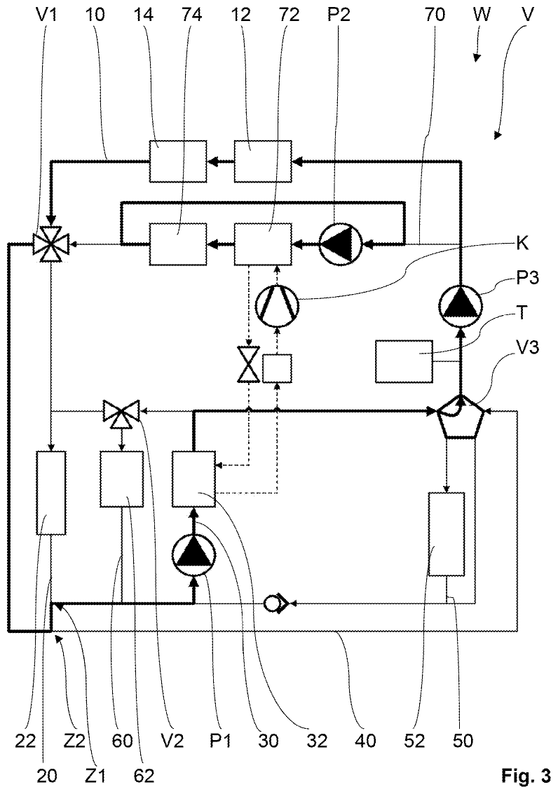

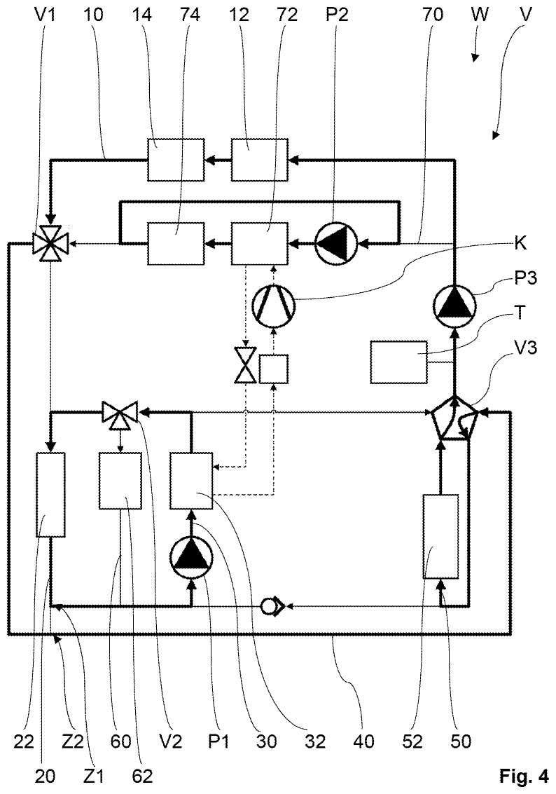

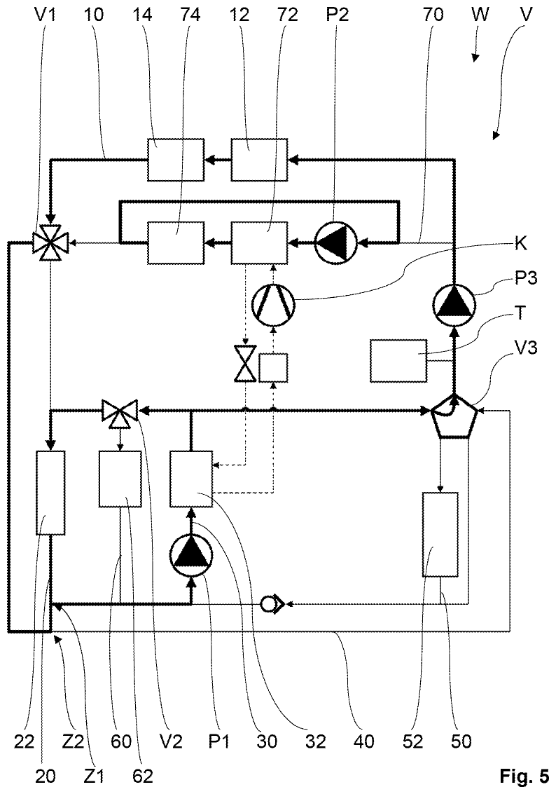

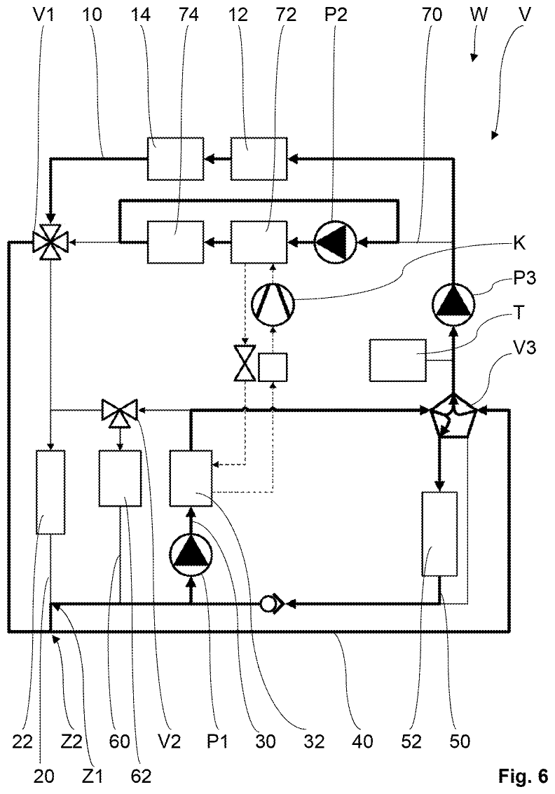

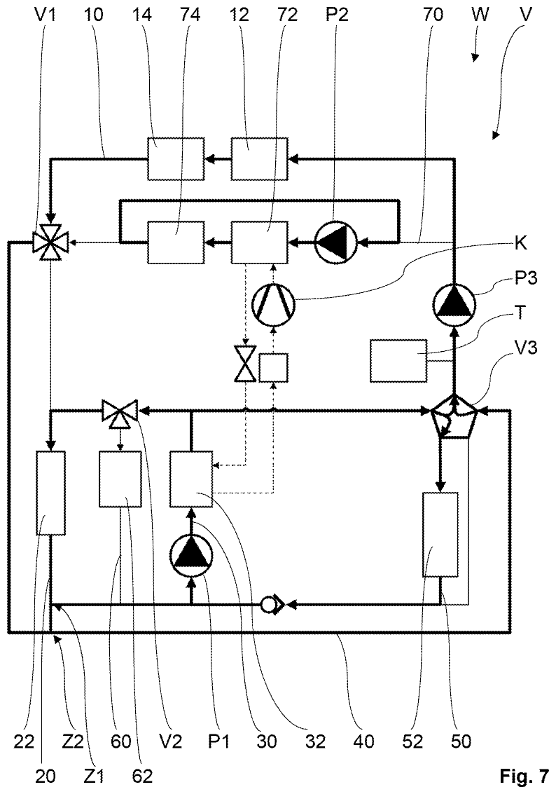

Furthermore, the heat pump system W is designed in such a way that, in a third operating state of the heat pump system W, a coolant flow 3A passes through the first flow section 10, then through the coolant branch Z2, then through the coolant branch Z1, and then through the third flow section 30; see FIG. 3; and
that in a fourth operating state of the heat pump system W, a coolant flow 4A of the coolant passes through the first flow section 10, then through the coolant branch Z2, then through the fourth flow section 40, and then through the fifth flow section 50, while at the same time, a coolant flow 4B of the coolant passes separately through the third flow section 30; see FIG. 4; and
that in a fifth operating state of the heat pump system W, a coolant flow 5A of the coolant passes through the first flow section 10, then through the coolant branch Z2, then through the coolant branch Z1, and then through the third flow section 30, while at the same time, a coolant flow 5B of the coolant passes through the second flow section 20, then through the coolant branch Z1, and then through the third flow section 30. Accordingly, the coolant flow 5A connects the heat source 12, 14 in the first flow section 10 to the heat exchanger 32 in series in the third flow section 30, and at the same time, the coolant flow 5B connects the heat exchanger 22 in the second flow section 20, likewise in series, to the heat exchanger 32 in the third flow section 30, wherein the heat source 12, 14 in the first flow section 10 and the heat exchanger 22 in the second flow section 20 are arranged in parallel to one another; see FIG. 5; and
that in a sixth operating state of the heat pump system W, on the one hand a coolant flow 6A of the coolant passes through the first flow section 10, then through the coolant branch Z2, and then through the fourth flow section 40, and on the other hand a coolant flow 6B of the coolant passes through the first flow section 10, then through the coolant branch Z2, then through the coolant branch Z1, and then through the third flow section 30; see FIG. 6; and
that in a seventh operating state of the heat pump system W, on the one hand a coolant flow 7A of the coolant passes through the first flow section 10, then through the coolant branch Z2, and then through the fourth flow section 40, and on the other hand a coolant flow 7B of the coolant passes through the first flow section 10, then through the coolant branch Z2, then through the coolant branch Z1, and then through the third flow section 30, and in addition to the coolant flow 7A and the coolant flow 7B, a coolant flow 7C passes through the second flow section 20, then through the coolant branch Z1, and then through the third flow section 30; see FIG. 7.

The heat pump system W is explained in greater detail below with reference to FIGS. 1 through 7. Coolant lines through which coolant flows, in particular flow sections 10 through 70, are denoted by thick solid lines. Coolant lines through which coolant does not flow in the respective operating state of the heat pump system W, in particular flow sections 10 through 70, are illustrated in FIGS. 1 through 7 with thin solid lines. The refrigerant-side lines are shown with dashed lines. Flow arrows indicate the respective flow direction of the coolant and of the refrigerant.

The first operating state according to FIG. 1, also referred to as operating state 1.1: The drive train formed by the power electronics unit 12 and the electric motor 14 is cooled by the front radiator 22. The valve V1 directs the heated coolant flow from the drive train 12, 14 to the front radiator 22. Downstream from the front radiator 22, the coolant is returned to the drive train 12, 14 via the valve V3. The liquid-cooled condenser 72, or LCC 72 for short, is cooled by the front radiator 22, or radiator 22 for short. The valve V1 directs the heated coolant flow from the LCC 72 to the radiator 22. Downstream from the radiator 22, the coolant is returned via the valve V3. The seventh flow section 70 to the valve V1, which is fluidically parallel to the drive train 12, 14, enables parallel flow through the LCC 72 and the drive train 12, 14 with respect to the radiator 22, so that the above-mentioned components can be cooled with the cool coolant from the radiator 22. This improves the system efficiency compared to a serial arrangement of the above-mentioned components, in which the LCC 72 must be cooled with the warm coolant from the drive train 12, 14. The valve V1 enables proportional distribution of the coolant flow between the drive train 12, 14 and the LCC 72. This allows the cooling to be adjusted as needed for the refrigerant system, namely, the LCC 72. The term “refrigerant system” represents the refrigerant side of the heat pump system W; the same applies to the term “coolant system” and the coolant side of the heat pump system W. The vehicle battery 52, or battery 52 for short, is cooled via the chiller 32. The interior cooler 62, designed as an interior radiator, is likewise cooled via the chiller 32. The coolant flow for both of the above-mentioned components is divided via the valve V2 and/or the valve V3.

The second operating state according to FIG. 2, also referred to as operating state 2.1: The battery 52 is thermally separate from the remainder of the thermal management system, i.e., the remainder of the heat pump system W. The drive train 12, 14 is connected to itself via the valves V1 and V3 and is heated by its own lost heat. The chiller 32 is connected to the radiator 22 and supplies it with supercooled coolant, so that ambient air flowing through the radiator 22 releases heat to the coolant. This heat is then transferred from the chiller 32 to the refrigerant system of the heat pump system W. The LCC 72 releases heat to the seventh flow section 70, so that heat is stored therein or, if necessary, transferred to the vehicle cabin via the interior heater 74, which is designed as an interior radiator. The interior cooler 62, which is likewise designed as an interior radiator, is cooled, if necessary, via the chiller 32. This case is not illustrated in FIG. 2. The coolant flow is divided via the valve V2.

The third operating state according to FIG. 3, also referred to as operating state 3.1: The battery 52 is thermally separate from the remainder of the thermal management system. The chiller 32 is connected to the drive train 12, 14 and supplies it with supercooled coolant, so that the drive train 12, 14 releases heat to the coolant. The corresponding heat is then transferred from the chiller 32 to the refrigerant system of the heat pump system W. The LCC 72 releases heat to the seventh flow section 70, so that heat is stored therein or, if necessary, transferred to the vehicle cabin via the heater 74, which is designed as an interior radiator. The interior radiator 62 is cooled, if necessary, via the chiller 32. This case is not illustrated in FIG. 3. The coolant flow is divided via the valve V2.

The fourth operating state according to FIG. 4, also referred to as

operating state 5.1: The drive train 12, 14 is connected to the battery 52 via the valves V1 and V3, and heats the battery through the drive train's own lost heat. The chiller 32 is connected to the radiator 22 and supplies it with supercooled coolant, so that the ambient air flowing through the radiator 22 releases heat to the coolant. This heat is then transferred from the chiller 32 to the refrigerant system of the heat pump system W. The LCC 72 releases heat to the seventh flow section 70, so that heat is stored therein or, if necessary, transferred to the vehicle cabin via the interior radiator 74. The interior radiator 62 is cooled, if necessary, via the chiller 32. This case is not illustrated in FIG. 4. The coolant flow is divided via the valve V2.

The fifth operating state according to FIG. 5, also referred to as operating state 3.3: The battery 52 is thermally separate from the remainder of the thermal management system. The chiller 32 is connected to the drive train 12, 14 and supplies it with supercooled coolant, so that the drive train 12, 14 releases heat to the coolant. This heat is then transferred from the chiller 32 to the refrigerant system of the heat pump system W. The chiller 32 is also connected to the radiator 22 and supplies it with supercooled coolant, so that the ambient air flowing through the radiator 22 releases heat to the coolant. This heat is then transferred from the chiller 32 to the refrigerant system of the heat pump system W. The coolant flow is divided via the valve V2. The LCC 72 releases heat to the seventh flow section 70, so that heat is stored therein or, if necessary, transferred to the vehicle cabin via the interior radiator 74.

The sixth operating state according to FIG. 6, also referred to as operating state 4.1: The chiller 32 is connected to the battery 52 and the drive train 12, 14 and supplies them with supercooled coolant, so that the battery 52 and the drive train 12, 14 release heat to the coolant. This heat is then transferred from the chiller 32 to the refrigerant system of the heat pump system W. By use of the valve V3, it is possible to adjust which portion of the coolant flow from the first flow section 10 is conducted through the chiller 32 and which portion bypasses the chiller 32. This allows the amount of heat supplied to the chiller 32 to be controlled as needed. The LCC 72 releases heat to the seventh flow section 70, so that heat is stored therein or, if necessary, transferred to the vehicle cabin via the interior radiator 74. The interior radiator 62 is cooled, if necessary, via the chiller 32. This case is not illustrated in FIG. 6. The coolant flow is divided via the valve V2.

The seventh operating state according to FIG. 7, also referred to as operating state 4.3: The chiller 32 is connected to the battery 52 and the drive train 12, 14 and supplies them with supercooled coolant, so that the battery 52 and the drive train 12, 14 release heat to the coolant. This heat is then transferred from the chiller 32 to the refrigerant system of the heat pump system W. By use of the valve V3, it is possible to adjust which portion of the coolant flow from the first flow section 10 is conducted through the chiller 32 and which portion bypasses the chiller 32. This allows the amount of heat supplied to the chiller 32 to be controlled as needed. The chiller 32 is also connected to the radiator 22 and supplies it with supercooled coolant, so that the ambient air flowing through the radiator 22 releases heat to the coolant. This heat is then transferred from the chiller 32 to the refrigerant system of the heat pump system W. The coolant flow is divided via the valve V2. The LCC 72 releases heat to the seventh flow section 70, so that heat is stored therein or, if necessary, transferred to the vehicle cabin via the interior radiator 74.

In addition to the seven operating states stated above, the following further operating states may be realized using the heat pump system W; the numbering of the individual operating states indicates their proximity to one of the above-mentioned operating states. For example, operating state 1.2 is similar to operating state 1.1. Accordingly, a match in the first digit in the designation of the operating mode indicates very similar operating states, while the second digit in the designation of the operating mode represents a variant designation. In other respects, reference is made to the relevant differences between the respective stated operating state and the closest above-mentioned operating state; otherwise, reference may essentially be made to this above-mentioned operating state.

Operating state 1.2: The drive train 12, 14 is cooled via the radiator 22. The valve V1 directs the heated coolant flow from the drive train 12, 14 to the radiator 22. Downstream from the radiator 22, the coolant is returned to the drive train 12, 14 via the valve V3. The LCC 72 releases heat to the seventh flow section 70, so that heat is stored therein or, if necessary, transferred to the vehicle cabin via the interior radiator 74. The battery 52 is cooled via the chiller 32. The interior radiator 62 is likewise cooled via the chiller 32. The coolant flow for both of the above-mentioned components is divided via the valves V2 and V3. In contrast to the first operating state, namely, operating state 1.1, the coolant is circulated through the LCC 72 and the interior radiator 74 via the pump P2 and is not introduced into the flow section 20 via the valve V1.

Operating state 2.2: The battery 52 is thermally separate from the remainder of the thermal management system. The drive train 12, 14 is connected to itself via the valves V1 and V3 and is heated by its own lost heat. The chiller 32 is connected to the radiator 22 and supplies it with supercooled coolant, so that the ambient air flowing through the radiator 22 releases heat to the coolant. This heat is then transferred from the chiller 32 to the refrigerant system of the heat pump system W. The LCC 72 releases heat to the seventh flow section 70, so that heat is stored therein or, if necessary, transferred to the vehicle cabin via the interior radiator 74. In addition, a portion of the heat from the seventh flow section 70 is proportionally supplied to the chiller 32 via the valve V1, so that this heat is once again transferred to the refrigerant system. The cooled coolant then flows back into the seventh flow section 70 via the valve V3. This generates additional lost heat in the refrigerant compressor K, or compressor K for short, which is available as additional heating power in the seventh flow section 70. By use of the valve V3, it is possible to adjust which portion of the coolant flow from the seventh flow section 70 and/or the first flow section 10 is conducted through the chiller 32 and which portion bypasses the chiller 32. This allows the amount of heat supplied to the chiller 32 to be controlled as needed. Optionally, the pumps P2 and P3 may be actuated in such a way that the volume flow of the coolant through the drive train 12, 14 is reduced to a minimum. This allows the influence of the thermal mass of the drive train 12, 14, and thus the time required to heat the seventh flow section 70, to be reduced during a warm-up phase. The interior radiator 62 is cooled via the chiller 32 if necessary. The coolant flow is divided via the valve V2. In contrast to the second operating state, namely, operating state 2.1, the coolant is only partially circulated through the LCC 72 and the interior radiator 74 via the pump P2. The remainder of the above-mentioned coolant flow is relayed to the coolant branch Z2 via the valve V1. From there, the coolant also flows to the coolant branch Z1. Furthermore, the coolant downstream from the chiller 32 is divided between the valve V2 and the valve V3, so that this coolant on the one hand passes through the front radiator 22, and on the other hand connects to the coolant flow that flows to the pump P3.

Operating state 2.3: The battery 52 is thermally separate from the remainder of the thermal management system. The drive train 12, 14 is connected to itself via the valves V1 and V3 and is heated by its own lost heat. The LCC 72 releases heat to the seventh flow section 70, so that heat is stored therein or, if necessary, transferred to the vehicle cabin via the interior radiator 74. In addition, a portion of the heat from the seventh flow section 70 is proportionally supplied to the chiller 32 via the valve V1, so that this heat is once again transferred to the refrigerant system. The cooled coolant then flows back into the seventh flow section 70 via the valve V3. This generates additional lost heat in the compressor K, which is available as additional heating power in the seventh flow section 70. By use of the valve V3, it is possible to adjust which portion of the coolant flow from the seventh flow section 70 and/or the first flow section 10 is conducted through the chiller 32 and which portion bypasses the chiller 32. This allows the amount of heat supplied to the chiller 32 to be controlled as needed. Optionally, the pumps P2 and P3 may be actuated in such a way that the volume flow through the drive train 12, 14 is reduced to a minimum. This allows the influence of the thermal mass of the drive train 12, 14, and thus the time required to heat the seventh flow section 70, to be reduced during a warm-up phase. The interior radiator 62 is cooled via the chiller 32, if necessary. The coolant flow is divided via the valve V2. In contrast to the above-mentioned operating state 2.2, the coolant is not divided between the valves V2 and V3 downstream from the chiller 32. Instead, the coolant downstream from the chiller 32 is simply relayed to the valve V3. Accordingly, there is also no flow through the front radiator 22. Instead, via the valve V3 this coolant connects to the coolant flow that flows to the pump P3.

Operating state 3.2: The battery 52 is thermally separate from the remainder of the thermal management system. The chiller 32 is connected to the drive train 12, 14 and supplies it with supercooled coolant, so that the drive train 12, 14 releases heat to the coolant. This heat is then transferred from the chiller 32 to the refrigerant system of the heat pump system W. The LCC 72 releases heat to the seventh flow section 70, so that heat is stored therein or, if necessary, transferred to the vehicle cabin via the interior radiator 74. In addition, a portion of the heat from the seventh flow section 70 is proportionally supplied to the chiller 32 via the valve V1, so that this heat is once again transferred to the refrigerant system. The cooled coolant then flows back via the valve V3 into the seventh flow section 70. This generates additional lost heat in the compressor K, which is available as additional heating power in the seventh flow section 70. Optionally, the pumps P2 and P3 may be actuated in such a way that the volume flow through the drive train 12, 14 is reduced to a minimum. This allows the influence of the thermal mass of the drive train 12, 14, and thus the time required to heat the seventh flow section 70, to be reduced during a warm-up phase. The interior radiator 62 is cooled via the chiller 32 if necessary. The coolant flow is divided via the valve V2. In contrast to the third operating state, namely, operating state 3.1, the coolant is only partially circulated through the LCC 72 and the interior radiator 74 via the pump P2. The remainder of the above-mentioned coolant flow is relayed to the coolant branch Z2 via the valve V1. From there, on the one hand it flows back into the first flow section 10, analogously to the third operating state, and on the other hand flows into the seventh flow section 70.

Operating state 3.4: The battery 52 is thermally separate from the remainder of the thermal management system. The chiller 32 is connected to the drive train 12, 14 and supplies it with supercooled coolant, so that the drive train 12, 14 releases heat to the coolant. This heat is then transferred from the chiller 32 to the refrigerant system of the heat pump system W. The chiller 32 is also connected to the radiator 22 and supplies it with supercooled coolant, so that the ambient air flowing through the radiator 22 releases heat to the coolant. This heat is then transferred from the chiller 32 to the refrigerant system of the heat pump system W. The coolant flow is divided via the valve V2. The LCC 72 releases heat to the seventh flow section 70, so that heat is stored therein or, if necessary, transferred to the vehicle cabin via the interior radiator 74. In addition, a portion of the heat from the seventh flow section 70 is proportionally supplied to the chiller 32 via the valve V1, so that this heat is once again transferred to the refrigerant system. The cooled coolant then flows back through the valve V3 into the seventh flow section 70. This generates additional lost heat in the compressor K, which is available as additional heating power in the seventh flow section 70. Optionally, the pumps P2 and P3 may be actuated in such a way that the volume flow through the drive train 12, 14 is reduced to a minimum. This allows the influence of the thermal mass of the drive train 12, 14, and thus the time required to heat the seventh flow section 70, to be reduced during a warm-up phase. In contrast to the fifth operating state, namely, operating state 3.3, the coolant is only partially circulated through the LCC 72 and the interior radiator 74 via the pump P2. The remainder of the above-mentioned coolant flow is relayed directly to the coolant branch Z2 via the valve V1. From there, on the one hand it flows back into the first flow section 10, analogously to the fifth operating state, and on the other hand flows into the seventh flow section 70.

Operating state 4.2: The chiller 32 is connected to the battery 52 and the drive train 12, 14 and supplies them with supercooled coolant, so that first the battery 52 and then the drive train 12, 14 release heat to the coolant. This heat is then transferred from the chiller 32 to the refrigerant system of the heat pump system W. By use of the valve V3, it is possible to adjust which portion of the coolant flow from the first flow section 10 is conducted through the chiller 32 and which portion bypasses the chiller 32. This allows the amount of heat supplied to the chiller 32 to be controlled as needed. The LCC 72 releases heat to the seventh flow section 70, so that heat is stored therein or, if necessary, transferred to the vehicle cabin via the interior radiator 74. In addition, a portion of the heat from the seventh flow section 70 is proportionally supplied to the chiller 32 via the valve V1, so that this heat is once again transferred to the refrigerant system. The cooled coolant then flows back into the seventh flow section 70 via the valve V3. This generates additional lost heat in the compressor K, which is available as additional heating power in the seventh flow section 70. Optionally, the pumps P2 and P3 may be actuated in such a way that the volume flow through the drive train 12, 14 is reduced to a minimum. This allows the influence of the thermal mass of the drive train 12, 14, and thus the time required to heat the seventh flow section 70, to be reduced during a warm-up phase. The interior radiator 62 is cooled via the chiller 32 if necessary. The coolant flow is divided via the valve V2. In contrast to the sixth operating state, namely, operating state 4.1, the coolant is only partially circulated through the LCC 72 and the interior radiator 74 via the pump P2. The remainder of the above-mentioned coolant flow is relayed directly to the coolant branch Z2 via the valve V1. From there, on the one hand it flows back into the first flow section 10, analogously to the sixth operating state, and on the other hand flows into the seventh flow section 70.

Operating state 4.4: The chiller 32 is connected to the battery 52 and the drive train 12, 14 and supplies them with supercooled coolant, so that the battery 52 and the drive train 12, 14 release heat to the coolant. This heat is then transferred from the chiller 32 to the refrigerant system of the heat pump system W. By use of the valve V3, it is possible to adjust which portion of the coolant flow from the first flow section 10 is conducted through the chiller 32 and which portion bypasses the chiller 32. This allows the amount of heat supplied to the chiller 32 to be controlled as needed. The chiller 32 is also connected to the radiator 22 and supplies it with supercooled coolant, so that the ambient air flowing through the radiator 22 releases heat to the coolant. This heat is then transferred from the chiller 32 to the refrigerant system of the heat pump system W. The coolant flow is divided via the valve V2. The LCC 72 releases heat to the seventh flow section 70, so that heat is stored therein or, if necessary, transferred to the vehicle cabin via the interior radiator 74. In addition, a portion of the heat from the seventh flow section 70 is proportionally supplied to the chiller 32 via the valve V1, so that this heat is once again transferred to the refrigerant system. The cooled coolant then flows back into the seventh flow section 70 via the valve V3. This generates additional lost heat in the compressor K, which is available as additional heating power in the seventh flow section 70. Optionally, the pumps P2 and P3 may be actuated in such a way that the volume flow through the drive train 12, 14 is reduced to a minimum. This allows the influence of the thermal mass of the drive train 12, 14, and thus the time required to heat the seventh flow section 70, to be reduced during a warm-up phase. In contrast to the seventh operating state, namely, operating state 4.3, the coolant is only partially circulated through the LCC 72 and the interior radiator 74 via the pump P2. The remainder of the above-mentioned coolant flow is relayed directly to the coolant branch Z2 via the valve V1. From there, on the one hand it flows back into the first flow section 10, analogously to the seventh operating state, and on the other hand flows into the seventh flow section 70.

Operating state 5.2: The drive train 12, 14 is connected to the battery 52 via the valves V1 and V3, and heats the battery through the drive train's own lost heat. The chiller 32 is connected to the radiator 22 and supplies it with supercooled coolant, so that the ambient air flowing through the radiator 22 releases heat to the coolant. This heat is then transferred from the chiller 32 to the refrigerant system of the heat pump system W. The LCC 72 releases heat to the seventh flow section 70, so that heat is stored therein or, if necessary, transferred to the vehicle cabin via the interior radiator 74. In addition, a portion of the heat from the seventh flow section 70 is likewise proportionally supplied to the battery 52 via the valve V1, so that this heat heats the battery 52. The cooled coolant then flows back into the seventh flow section 70 via the valve V3. By use of the valve V3, it is possible to adjust which portion of the coolant flow from the seventh flow section 70 and/or the first flow section 10 is conducted through the battery 52 or via the chiller 32. This allows the amount of heat supplied to the chiller 32 to be controlled as needed. Optionally, the pumps P2 and P3 may be actuated in such a way that the volume flow through the drive train 12, 14 is reduced to a minimum. This allows the influence of the thermal mass of the drive train 12, 14, and thus the time required to heat the seventh flow section 70, to be reduced during a warm-up phase. In contrast to the fourth operating state, namely, operating state 5.1, the coolant is only partially circulated through the LCC 72 and the interior radiator 74 via the pump P2. The remainder of the above-mentioned coolant flow is relayed directly to the coolant branch Z2 via the valve V1. Furthermore, the coolant is divided downstream from the chiller 32 between the valve V2 and the valve V3, so that the coolant on the one hand flows through the front radiator 22, and on the other hand connects with the coolant flow to the pump P3. From there, on the one hand it flows back into the first flow section 10, analogously to the fourth operating state, and on the other hand flows into the seventh flow section 70.

Operating state 5.3: The drive train 12, 14 is connected to the battery 52 via the valves V1 and V3, and heats the battery through the drive train's own lost heat. The LCC 72 releases heat to the seventh flow section 70, so that heat is stored therein or, if necessary, transferred to the vehicle cabin via the interior radiator 74. In addition, a portion of the heat from the seventh flow section 70 is likewise proportionally supplied to the battery 52 via the valve V1, so that this heat heats the battery 52. The cooled coolant then flows back into the seventh flow section 70 via the valve V3. By use of the valve V3, it is possible to adjust which portion of the coolant flow from the seventh flow section 70 and/or the first flow section 10 is conducted through the battery 52 or via the chiller 32. This allows the amount of heat supplied to the chiller 32 to be controlled as needed. Optionally, the pumps P2 and P3 may be actuated in such a way that the volume flow through the drive train 12, 14 is reduced to a minimum. This allows the influence of the thermal mass of the drive train 12, 14, and thus the time required to heat the seventh flow section 70, to be reduced during a warm-up phase. In contrast to the above-mentioned operating state 5.2, the coolant flow downstream from the chiller 32 is relayed only to the valve V3, where it joins the coolant flow downstream from the battery 52 and continues to flow in the direction of the pump P3. Thus, coolant does not flow through the front radiator 22.

Operating state 5.4: The drive train 12, 14 is connected to the battery 52 via the valves V1 and V3, and heats the battery through the drive train's own lost heat. The chiller 32 is connected to the radiator 22 and supplies it with supercooled coolant, so that the ambient air flowing through the radiator 22 releases heat to the coolant. This heat is then transferred from the chiller 32 to the refrigerant system of the heat pump system W. The LCC 72 releases heat to the seventh flow section 70, so that heat is stored therein or, if necessary, transferred to the vehicle cabin via the interior radiator 74. In addition, a portion of the heat from the seventh flow section 70 is likewise proportionally supplied to the battery 52 via the valve V1, so that this heat heats the battery 52. The cooled coolant then flows back into the seventh flow section 70 via the valve V3. Optionally, the pumps P2 and P3 may be actuated in such a way that the volume flow through the drive train 12, 14 is reduced to a minimum. This allows the influence of the thermal mass of the drive train 12, 14, and thus the time required to heat the seventh flow section 70, to be reduced during a warm-up phase. In contrast to the fourth operating state, namely, operating state 5.1, the coolant is only partially circulated through the LCC 72 and the interior radiator 74 via the pump P2. The remainder of the above-mentioned coolant flow is relayed to the coolant branch Z2 via the valve V1, the same as the coolant from the first flow section 10. From there, on the one hand it flows back into the first flow section 10, analogously to the fourth operating state, and on the other hand flows into the seventh flow section 70.

Operating state 6.1: The drive train 12, 14 is connected to itself via the valves V1 and V3 and is heated by its own lost heat. The chiller 32 is connected to the battery 52 and supplies it with supercooled coolant, so that the battery 52 releases heat to the coolant. This heat is then transferred from the chiller 32 to the refrigerant system of the heat pump system W. The LCC 72 releases heat to the seventh flow section 70, so that heat is stored therein or, if necessary, transferred to the vehicle cabin via the interior radiator 74. The interior radiator 62 is cooled, if necessary, via the chiller 32. The coolant flow is divided via the valve V2.

Operating state 6.2: The drive train 12, 14 is connected to itself via the valves V1 and V3 and is heated by its own lost heat. The chiller 32 is connected to the battery 52 and supplies it with supercooled coolant, so that the battery 52 releases heat to the coolant. This heat is then transferred from the chiller 32 to the refrigerant system of the heat pump system W. The LCC 72 releases heat to the seventh flow section 70, so that heat is stored therein or, if necessary, transferred to the vehicle cabin via the interior radiator 74. In addition, a portion of the heat from the seventh flow section 70 is proportionally supplied to the chiller 32 via the valve V1, so that this heat is once again transferred to the refrigerant system. The cooled coolant then flows back into the seventh flow section 70 via the valve V3. This generates additional lost heat in the compressor K, which is available as additional heating power in the seventh flow section 70. By use of the valve V3, it is possible to adjust which portion of the coolant flow from the seventh flow section 70 and/or the first flow section 10 is conducted through the chiller 32 and which portion bypasses the chiller 32. This allows the amount of heat supplied to the chiller 32 to be controlled as needed. Optionally, the pumps P2 and P3 may be actuated in such a way that the volume flow through the drive train 12, 14 is reduced to a minimum. This allows the influence of the thermal mass of the drive train 12, 14, and thus the time required to heat the seventh flow section 70, to be reduced during a warm-up phase. The interior radiator 62 is cooled via the chiller 32 if necessary. The coolant flow is divided via the valve V2. In contrast to the above-mentioned operating state 6.1, only a portion of the coolant is circulated through the LCC 72 and the interior radiator 74 via the pump P2. The remainder of the above-mentioned coolant flow is relayed to the coolant branch Z2 via the valve V1. From there, a portion of the coolant flows analogously to operating state 6.1, and the remainder of this coolant flows through the coolant branch Z1, and then back into the first flow section 10 and the seventh flow section 70 via the valve V3 and the pump P1.

Operating state 6.3: The drive train 12, 14 is connected to itself via the valves V1 and V3 and is heated by its own lost heat. The chiller 32 is connected to the battery 52 and supplies it with supercooled coolant, so that the battery 52 releases heat to the coolant. This heat is then transferred from the chiller 32 to the refrigerant system of the heat pump system W. The chiller 32 is also connected to the radiator 22 and supplies it with supercooled coolant, so that the ambient air flowing through the radiator 22 releases heat to the coolant. This heat is then transferred from the chiller 32 to the refrigerant system of the heat pump system W. The coolant flow is divided between the radiator 22 and the battery 52 via the valve V2 and/or the valve V3. The LCC 72 releases heat to the seventh flow section 70, so that heat is stored therein or, if necessary, transferred to the vehicle cabin via the interior radiator 74. In contrast to operating state 6.1, the coolant flow downstream from the chiller 32 is divided between the valves V2 and V3, so that coolant also flows through the front radiator 22.

Operating state 6.4: The drive train 12, 14 is connected to itself via the valves V1 and V3 and is heated by its own lost heat. The chiller 32 is connected to the battery 52 and supplies it with supercooled coolant, so that the battery 52 releases heat to the coolant. This heat is then transferred from the chiller 32 to the refrigerant system of the heat pump system W. The chiller 32 is also connected to the radiator 22 and supplies it with supercooled coolant, so that the ambient air flowing through the radiator 22 releases heat to the coolant. This heat is then transferred from the chiller 32 to the refrigerant system of the heat pump system W. The coolant flow is divided between the radiator 22 and the battery 52 via the valve V2 and/or the valve V3. The LCC 72 releases heat to the seventh flow section 70, so that heat is stored therein or, if necessary, transferred to the vehicle cabin via the interior radiator 74. In addition, a portion of the heat from the seventh flow section 70 is proportionally supplied to the chiller 32 via the valve V1, so that this heat is once again transferred to the refrigerant system. The cooled coolant then flows back into the seventh flow section 70 via the valve V3. This generates additional lost heat in the compressor K, which is available as additional heating power in the seventh flow section 70. By use of the valve V3, it is possible to adjust which portion of the coolant flow from the seventh flow section 70 and/or the first flow section 10 is conducted through the chiller 32 and which portion bypasses the chiller 32. This allows the amount of heat supplied to the chiller 32 to be controlled as needed. Optionally, the pumps P2 and P3 may be actuated in such a way that the volume flow through the drive train 12, 14 is reduced to a minimum. This allows the influence of the thermal mass of the drive train 12, 14, and thus the time required to heat the seventh flow section 70, to be reduced during a warm-up phase. In contrast to the above-mentioned operating state 6.3, only a portion of the coolant is circulated through the LCC 72 and the interior radiator 74 via the pump P2. The remainder of the above-mentioned coolant flow is relayed to the coolant branch Z2 via the valve V1. From there, the coolant also flows through the coolant branch Z1. Furthermore, a portion of the coolant relayed to the valve V3 downstream from the chiller 32 no longer flows through the battery 52, and instead flows directly in the direction of the pump P3. Operating state 6.4 thus largely corresponds to operating state 6.1, except that in operating state 6.1, coolant also flows through the radiator 22.

Operating state 7.1: The battery 52 and then the drive train 12, 14 are cooled via the radiator 22. Downstream from the radiator 22, the coolant is initially returned to the battery 52 via the valve V3, and then once again to the drive train 12, 14 via the valve V3. The LCC 72 is cooled via the radiator 22. The valve V1 directs the heated coolant flow from the LCC 72 to the radiator 22. Downstream from the radiator 22, the coolant is returned via the valve V3. The seventh flow section 70 to the valve V1, which is fluidically parallel to the drive train 12, 14, enables parallel flow through the LCC 72 and the drive train 12, 14 with respect to the radiator 22, so that the above-mentioned components may be cooled with the cool coolant from the radiator 22. This improves the system efficiency compared to a serial arrangement in which the LCC 72 must be cooled with the warm coolant from the drive train 12, 14. The valve V1 enables proportional distribution of the coolant flow between the drive train 12, 14, and the LCC 72. This allows the cooling of the refrigerant system, namely, the LCC 72, to be adjusted as needed. The interior radiator 62 is cooled via the chiller 32 if necessary. In contrast to the fourth operating state, namely, operating state 5.1, the coolant does not flow from the valve V1 directly to the coolant branch Z2, and instead this coolant initially flows through the front radiator 22. Furthermore, independently of same a coolant flow circulates between the chiller 32 and the interior radiator 62 via the pump P1. In addition, only a portion of the coolant is circulated through the LCC 72 and the interior radiator 74 via the pump P2. The remainder of the above-mentioned coolant flow is combined with the coolant flow from the first flow section 10 via the valve V1 and relayed to the coolant branch Z2 as explained above.

Operating state 7.2: The battery 52 and then the drive train 12, 14 are cooled via the radiator 22. Downstream from the radiator 22, the coolant is initially returned to the battery 52 via the valve V3 and then once again to the drive train 12, 14 via the valve V3. The LCC 72 releases heat to the seventh flow section 70, so that heat is stored therein or, if necessary, transferred to the vehicle cabin via the interior radiator 74. The interior radiator 62 is cooled, if necessary, via the chiller 32. In contrast to the above-mentioned operating state 7.1, the coolant flowing through the seventh flow section 70, analogously to the fourth operating state, is circulated only through the LCC 72 and the interior radiator 74 via the pump P2.

The invention is not limited to the present exemplary embodiment. For example, the invention may also be advantageously used in other vehicles.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A heat pump system for an electrically operated vehicle, the heat pump system comprising:
a coolant side for circulating a coolant, the coolant side comprising a first flow section for the coolant, a second flow section for the coolant, a third flow section for the coolant, a fourth flow section for the coolant, a valve system for the coolant-side distribution of the coolant, and a first and second coolant branch; and
a refrigerant side, fluidically separate from the coolant side, for circulating a refrigerant, the coolant side and the refrigerant side being in a heat transfer connection,
wherein, in a first operating state of the heat pump system, a first coolant flow of the coolant passes through the first flow section, then through the second flow section, then through the first coolant branch, then through the second coolant branch, and then through the fourth flow section, while at the same time, a coolant flow of the coolant passes separately through the third flow section, and
wherein, in a second operating state of the heat pump system, a second coolant flow of the coolant passes through the first flow section, then through the second coolant branch, and then through the fourth flow section, while at the same time, a coolant flow of the coolant passes separately through the second flow section, then through the first coolant branch, and then through the third flow section.

2. The heat pump system according to claim 1, wherein the heat pump system is designed such that in a third operating state of the heat pump system a third coolant flow passes through the first flow section, then through the second coolant branch, then through the first coolant branch, and then through the third flow section.

3. The heat pump system according to claim 1, wherein the heat pump system W has a fifth flow section for the coolant, wherein the fifth flow section is connectable to the third flow section and/or to the fourth flow section via the valve system.

4. The heat pump system according to claim 3, wherein the heat pump system is designed such that in a fourth operating state of the heat pump system, a fourth coolant flow of the coolant passes through the first flow section, then through the second coolant branch, then through the fourth flow section, and then through the fifth flow section, while at the same time, a further fourth coolant flow of the coolant flows separately through the third flow section.

5. The heat pump system according to claim 1, wherein the heat pump system is designed such that in a fifth operating state of the heat pump system, a fifth coolant flow of the coolant passes through the first flow section, then through the second coolant branch, then through the first coolant branch, and then through the third flow section, while at the same time, a further fifth coolant flow of the coolant passes through the second flow section, then through the first coolant branch, and then through the third flow section.

6. The heat pump system according to claim 1, wherein the heat pump system is designed such that in a sixth operating state of the heat pump system W, a sixth coolant flow of the coolant passes through the first flow section, then through the second coolant branch, and then through the fourth flow section, and/or a further sixth coolant flow of the coolant passes through the first flow section, then through the second coolant branch, then through the first coolant branch, and then through the third flow section.

7. The heat pump system according to claim 1, wherein the heat pump system is designed such that in a seventh operating state of the heat pump system W, a seventh coolant flow of the coolant passes through the first flow section, then through the second coolant branch, and then through the fourth flow section, and/or a further seventh coolant flow of the coolant passes through the first flow section, then through the second coolant branch, then through the first coolant branch, and then through the third flow section, and in addition to the seventh coolant flow and/or the further seventh coolant flow, an additional coolant flow passes through the second flow section, then through the first coolant branch, and then through the third flow section.

8. The heat pump system according to claim 1, wherein the heat pump system has a sixth flow section for the coolant, wherein the sixth flow section is connectable upstream in a flow-conducting manner to the third flow section via the valve system.

9. The heat pump system according to claim 1, wherein the heat pump system has a seventh flow section for the coolant, wherein the seventh flow section is arranged fluidically parallel to the first flow section and downstream from the second flow section such that a coolant flow of the coolant downstream from the second flow section is dividable into the first flow section and the seventh flow section via the valve system.

10. The heat pump system according to claim 1, wherein the first coolant branch and the second coolant branch are immediately and directly connected to one another in a flow-conducting manner.

11. The heat pump system according to claim 1, wherein a heat source is arranged in the first flow section, and/or wherein a heat exchanger for exchanging heat between the coolant and the open surroundings is arranged in the second flow section, and/or wherein a heat exchanger for cooling the coolant via the refrigerant is arranged in the third flow section.

12. The heat pump system according to claim 3, wherein a vehicle battery of the vehicle is arranged in the fifth flow section.

13. The heat pump system according to claim 8, wherein a heat exchanger for cooling air in a vehicle interior of the vehicle is arranged in the sixth flow section.

14. The heat pump system according to claim 9, wherein a heat exchanger for transferring heat to the coolant is arranged in the seventh flow section, and/or wherein a further heat exchanger for transferring heat to air in a vehicle interior of the vehicle is arranged in the seventh flow section.
